(19) United States
(12) Patent Application Publication
(10) Pub. No.: US 2010/0140548 A1
(43) Pub. Date: Jun. 10, 2010

(54) Nanoaggregate composition and method for making

(76) Inventors: Julia Xiaojun Zhao, Grand Forks, ND (US); Shuping Xu, Changchun (CN)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/378,093

(22) Filed: Feb. 11, 2009

Related U.S. Application Data
(60) Provisional application No. 61/027,555, filed on Feb. 11, 2008.

(51) Int. Cl. C09K 11/59

(52) U.S. Cl. 252/301.4 R

(57) ABSTRACT

A nanoaggregate composition and method for making nanoaggregate compositions constructed with one, two, and three nanoparticle building blocks includes coating the building blocks with a concentration of polyvinylpyrrolidone (PVP) molecules based on a known relationship between the concentration and an extent of aggregation of the building blocks, and producing nanoaggregates from the building blocks comprising a mixture of single-core nanoaggregates, double-core nanoaggregates, and triple-core nanoaggregates as a function of the extent of aggregation.

### CROSS-REFERENCE TO RELATED APPLICATION(S)

This application claims the benefit of U.S. Provisional Application No. 61/027,555 filed on Feb. 11, 2008, for “Method for Engineering Nanoaggregates” by Julia Xiaojun Zhao and Shuping Xu, which is incorporated by reference.

### BACKGROUND

The need for sensitive determinations of trace amounts of analytes has driven the rapid development of various novel nanomaterials. Photoactive nanomaterials, such as quantum dots (QDs), dye-doped nanoparticles, gold or silver nanoparticles, etc., are some of the most promising signaling reagents for achieving high detection sensitivity. These nanomaterials provide direct signals for the determination of trace analytes. However, the signal intensity of these nanomaterials is intrinsic and limited by their maximum value. To raise the limit of their intrinsic intensities, some form of signal amplification is needed. One alternative is photonic resonance enhancement. Noble metal nanostructures can generate an enlarged localized electromagnetic field through surface plasmon resonance and enhance the optical signals of the photoactive molecules within this electromagnetic field.

The principle of the localized surface plasmon resonance (LSPR) of metallic nanostructures has been investigated. At the nanoscale, the collective oscillations of metallic free electrons are limited by the nanostructure boundaries, and thus form surface plasmon waves along the interface. When the nanomaterial interface is irradiated by an incident light beam, the surface plasmon wave resonates with the optical wave at an optimized condition, resulting in the greatest absorption of the incident light. As a result, an enlarged localized electromagnetic field is manifested around the nanostructures, providing extra energy for signaling reagents present within this electromagnetic field. One remarkable example of this effect is surface enhanced Raman scattering (SERS). Using gold (Au) or silver (Ag) nanomaterials, SERS can enhance scattering signals by up to 10¹⁰ fold. The energy level of the electromagnetic field strongly depends on the metallic plasmon property of the nanomaterials. This property is determined by several factors, including the characteristics of the metal (size, shape, structure and dielectric constant), the surrounding medium (dielectric constant), the incident light (direction and wavelength) and so forth. Among these, the shape, size, and structure of the metal nanomaterials are critical to achieve controllable plasmonic materials and powerful surface enhanced matrices.

Aggregates of metallic nanoparticles generate higher signal enhancement than individual nanoparticles combined. Theoretical stimulations have demonstrated that the edge of nanostructures in general and the junction area between two nanoparticles in an aggregate exhibit a stronger localized electromagnetic field than other areas. Due to such an effect, research efforts have been focused on the developments of various metallic nanoaggregates. Despite the success of physical and electrical methods that require expensive instruments, such as electron-beam lithography, chemical self-assembly methods have shown great potential for economical and simple fabrication of metallic nanoaggregates. Traditionally, metal colloids have been aggregated by adding the proper chemicals, for example, salts (NaCl, KCl) and surfactants, or applying a beam of UV-vis light or laser to induce an accumulation. Colloidal self-aggregation at a two-phase interface has also been frequently used. However, these methods cannot control the shape and size of the nanoaggregates, resulting in a mixture of various irregular poly-core nanoaggregates. Although these nanoaggregates can enhance the surface plasmon, it is difficult to precisely control the extent of enhancement. Thus, the development of controllable and orderly metallic nanoaggregates using chemical methods remains a challenge.

### SUMMARY

A nanoaggregate composition and method for making nanoaggregate compositions constructed with one, two, and three nanoparticle building blocks includes coating the building blocks with polyvinylpyrrolidone (PVP) molecules based on a known relationship between the concentration of PVP and an extent of aggregation of the building blocks, and producing nanoaggregates from the building blocks comprising a mixture of single-core, double-core, and triple-core nanoaggregates as a function of the extent of aggregation.

### BRIEF DESCRIPTION OF THE DRAWINGS

FIG. 1 is a schematic representation of a method for engineering nanoaggregates.

FIG. 2 is a transmission electron microscope (TEM) image of nanoaggregate pre-building blocks, building blocks, PVP stabilized building blocks, and sandwich nanoaggregates produced by the method illustrated in FIG. 1.

FIG. 3A is a graph showing the UV-visible spectra of a gold (Au) shell growth process on nanoparticle cores to form building blocks.

FIG. 3B is a graph showing the UV-visible spectra of building blocks with different sized nanoparticle cores.

FIG. 4 is a graph showing the effect of polyvinylpyrrolidone concentration on the formation of single-core, double-core, triple-core and poly-core nanoaggregates.

FIG. 5 shows the TEM and scanning electron microscope (SEM) images of nanoaggregates separated by centrifugation into single-core, double-core, and triple and poly-core nanoaggregates.

FIG. 6 is a schematic diagram proposing a possible pathway on how the amount of PVP affects the extent of aggregation of nanoaggregate building blocks.

FIG. 7A shows TEM images of a series of seven single-core nanoaggregates with increasing thicknesses of a silica shell.

FIG. 7B shows the relationship between the thickness of the silica shell and the plasmon band positions of the seven single-core nanoparticles pictured in FIG. 7A.

FIG. 8 is a graph showing the fluorescence enhancement of nanoaggregates for near-infrared (NIR) dye molecules.

### DETAILED DESCRIPTION

Disclosed herein is a system and method for engineering nanoaggregates constructed with one, two, and three nanoparticle building blocks. It was surprisingly discovered that irregular poly-core aggregates of nanoparticles are greatly eliminated through adsorption of polyvinylpyrrolidone (PVP) molecules on the building block surface. Thus, by changing the PVP concentration, the yield of each type of nanoaggregate is adjustable and each type may be separated based on their weights. Furthermore, different sized aggregates exhibited distinct surface enhancement for amplifying near-infrared (NIR) signals when an NIR dye was placed in the electromagnetic field of the nanostructures, thus opening the door for applications of controlled surface enhancement in the sensitive detection of biological samples in the NIR region.

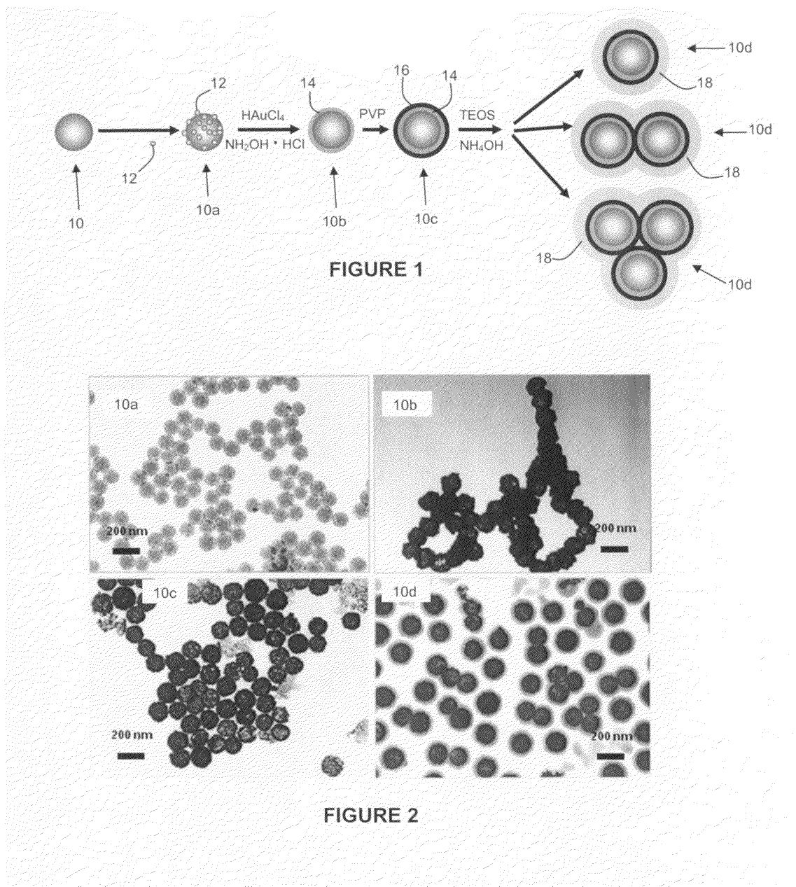

FIG. 1 is a schematic representation of a method of the present disclosure for developing SiO₂—Au—SiO₂ sandwich nanoaggregates, including SiO₂ nanoparticle 10, pre-building block 10a, SiO₂—Au core-shell building block 10b, stabilized building block 10c, nanoaggregate 10d, Au-nanoparticle 12, Au shell 14, PVP coating 16, and silica shell 18. Although gold (Au) is described in the following examples, other noble metals suitable for a SERS effect, such as silver (Ag) could also be used. The first step for developing the SiO₂—Au—SiO₂ sandwich nanoaggregates 10d entails developing a building block 10b of SiO₂—Au core-shell nanoparticles for stabilizing with PVP. The fabrication of stabilized building blocks 10c includes three major steps: 1) preparation of pre-building block 10a, 2) formation of building block 10b, and 3) stabilizing the block with PVP to form stabilized building block 10c. Gold (Au) is an excellent plasmonic material possessing long term stability and biocompatibility. But the LSPR band wavelengths of Au nanoparticles are in the visible region. To enhance NIR dye signals, the plasmon band in the NIR region was needed. SiO₂ nanoparticles 10 can induce a red shift of Au plasmon bands. Thus, pre-building block 10a was prepared by adsorbing Au nanoparticles 12 on SiO₂ nanoparticle 10 surface. SiO₂ nanoparticle 10 was modified with amine groups to provide positive charges for electrostatic adsorption of Au nanoparticles 12.

FIG. 2 shows transmission electron microscope (TEM) image of the pre-building blocks 10a with Au nanoparticles 12 adsorbed, as well as SiO₂—Au core-shell nanoparticle building blocks 10b, stabilized building blocks 10c, and nanoaggregates 10d. The SiO₂—Au nanoparticle pre-building blocks 10a were not stable. They would aggregate after they were removed from the ultrasonic bath in 30 min. The formation of SiO₂—Au building block 10a was completed through Au-nanoparticle 12 growth on the pre-building block 10a surface to form Au shell 14. A gold growth solution, chloroauric acid, was mixed with SiO₂—Au nanoparticle pre-building blocks 10a. With a reducing reagent (hydroxylamine hydrochloride) added, Au-nanoparticles 12 grew to form a uniform Au shell 14 on the SiO₂ nanoparticles 10 to form SiO₂—Au core-shell nanoparticle building blocks 10b as represented in FIG. 1 and pictured in FIG. 2.

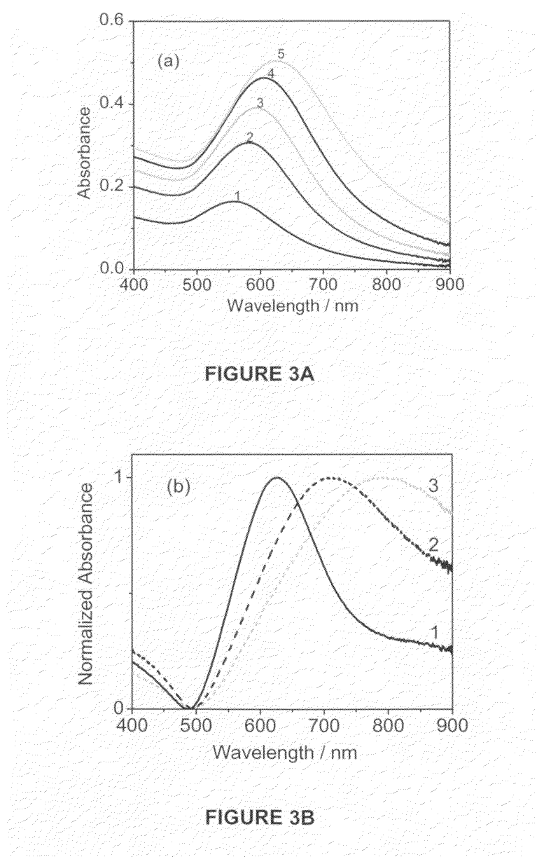

FIG. 3A is a graph showing the UV-vis spectra of the Au shell 14 growth process on SiO₂ nanoparticle 10 to form SiO₂—Au core-shell nanoparticle building blocks 10b. The wavelength of the plasmon band depended on the thickness of Au shell 14 and the size of the SiO₂ nanoparticle core 10. During the process of Au growth, the solution color changed from pink to purple, blue, and finally dark green. The color changes represented the red shifts of the plasmon peak as Au nanoparticles 12 on the silica particles 10 (curve 1 of FIG. 3(a)) became larger and joined to form a 14-nm Au shell 14 (curve 5 of FIG. 3(a)). The 14 nm Au shell 14 formed on SiO₂ nanoparticle 10 surface had a plasmon band at 626 nm (curve 5 of FIG. 3(a)). To shift the plasmon peak further to the NIR region, larger sizes of SiO₂ nanoparticles 10 were needed.

FIG. 3B is a graph showing the UV-vis spectra of SiO₂—Au core-shell nanoparticle building blocks 10b with different sized SiO₂ nanoparticle 10 cores. As the size of the SiO₂ nanoparticle 10 core was increased from 86±5 nm (curve 1 of FIG. 3(b)) to 130±6 nm in diameter (curve 3 of FIG. 3(b)), their plasmon band was shifted from 626 nm to 794 nm. SiO₂—Au core-shell nanoparticle building blocks 10b with a SiO₂ nanoparticle 10 core of 130±6 nm in diameter were chosen for further modification. When the stabilized building block 10c was doped into a silica matrix to form nanoaggregates 10d (described in more detail below), the plasmon band shifted to a longer wavelength.

FIG. 2 shows a TEM image of the various irregular aggregates that were spontaneously formed by building blocks 10b. To fabricate orderly nanoaggregates 10d, a short chain PVP molecule (average molecular weight of 10 kg/mol) was employed to modify the building block 10b surface. Different amounts of PVP were mixed with the building block 10b aqueous solution and each was reacted for 12 hours at a low stirring speed (400 rpm). Through adsorption of PVP hydrophilic side groups on the SiO₂—Au nanoparticle building block 10b, PVP coating 16 was formed. As shown in FIG. 2, the dispersibility of the SiO₂—Au core-sell nanoparticle building blocks 10b was improved dramatically with stabilized building block 10c having PVP coating 16. PVP is an amphiphilic and nonionic polymer which has been used as a stabilizer for preventing aggregation of nanomaterials, such as metal nanoparticles, metal oxides, polystyrene, etc. Under the methods of the present disclosure, the function of PVP is not only a stabilizer, but most importantly an adjuster for manipulating the extent of aggregation. It was discovered that the concentration of PVP played a key role in the control of the aggregation morphologies of building blocks 10b. By adjusting the number of PVP molecules per surface area of the nanoparticle building blocks 10b to produce stabilized building blocks 10c, as well as controlling the final silica coating process of stabilized building blocks 10c, the desired nanoaggregates 10d would be produced as described in more detail below.

FIG. 2 shows a TEM image of orderly nanoaggregates 10d formed under the methods of the present disclosure. The orderly formation of the nanoaggregates 10d progressed by doping the stabilized building blocks 10c in a silica matrix to form silica shell 18. Silica was chosen because it has no absorption in the visible and NIR region. Meanwhile, the optical properties of stabilized building blocks 10c were superiorly protected by silica shell 18. A modified Stöber method was employed to dope stabilized building blocks 10c into the silica matrix. Stabilized building blocks 10c were first dispersed in the Stöber synthesis solution and then started a slow aggregation. The extent of aggregation was controlled by the amount of PVP on stabilized building block 10c and the time of aggregation. Both conditions were controllable. The aggregation was stopped when tetraethylorthosilicate (TEOS) was added to the solution. To avoid formation of poly core aggregates, the aggregation was allowed for 10 min. The polymerization of TEOS produced silica shell 18 on the surface of the SiO₂—Au, forming a SiO₂—Au—SiO₂ sandwich nanostructure. With a suitable PVP coating 16 on the stabilized building blocks 10c and using the optimal aggregation time, the produced nanoaggregates 10d were largely limited to three types: single, double, triple and poly core sandwich nanostructures as shown in FIG. 2. The percentages of each type of nanostructures were tunable as the synthesis conditions changed. The conditions included: (1) the PVP concentration, (2) the amount of TEOS, and (3) the concentration of SiO2—Au stabilized building blocks 10c. Among them, the PVP concentration was a critical factor.

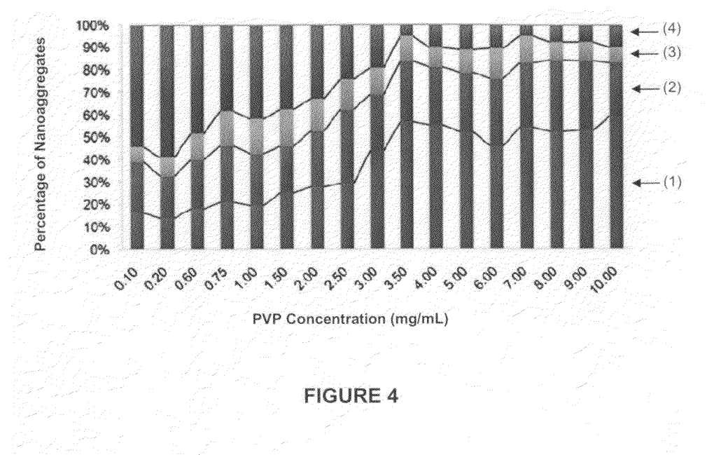

FIG. 4 is a graph showing the effect of PVP concentration on the formation of nanoaggregates 10d including four bands representing single-core (1), double-core (2), triple-core (3) and poly-core (4) (i.e., four or more) nanoaggregates 10d. Although PVP concentration should be calculated in the unit of number of PVP molecules per surface area of nanoparticles, to avoid errors, it is presented directly in the unit of mg/mL in FIG. 4. When low concentrations of PVP were used, a large portion of the products was irregular poly-core (4) aggregates. For instance, about 59% of the poly-core (4) aggregates was formed when the concentration of PVP≦0.20 mg/mL. Meanwhile, the percentages of the single (1), double (2), and triple-core (3) nanoaggregates were about 14%, 19%, and 8%. As the PVP concentration was increased, the percentage of poly-core (4) aggregates was greatly reduced. Finally, as the PVP concentration was over 3.5 mg/mL, the irregular poly-core (4) nanoaggregate percentage was limited to less than about 5%. The yield of the single-core (1) sandwich nanoparticles was adjustable in the range of about 16% to about 57%. The maximum percentage of the double-core (2) aggregates was about 33%. The triple-core (3) aggregates were adjustable in the range of about 7% to about 16%, which was relatively small compared to the single-core (1) and double-core (2) nanostructures. Based on above results, the yield of desired single (1), double (2), triple (3) and poly-core (4) nanoaggregates 10d may be controlled by adjusting the amount of PVP to favor the yield of the desired nanoaggregates under the methods of the present disclosure.

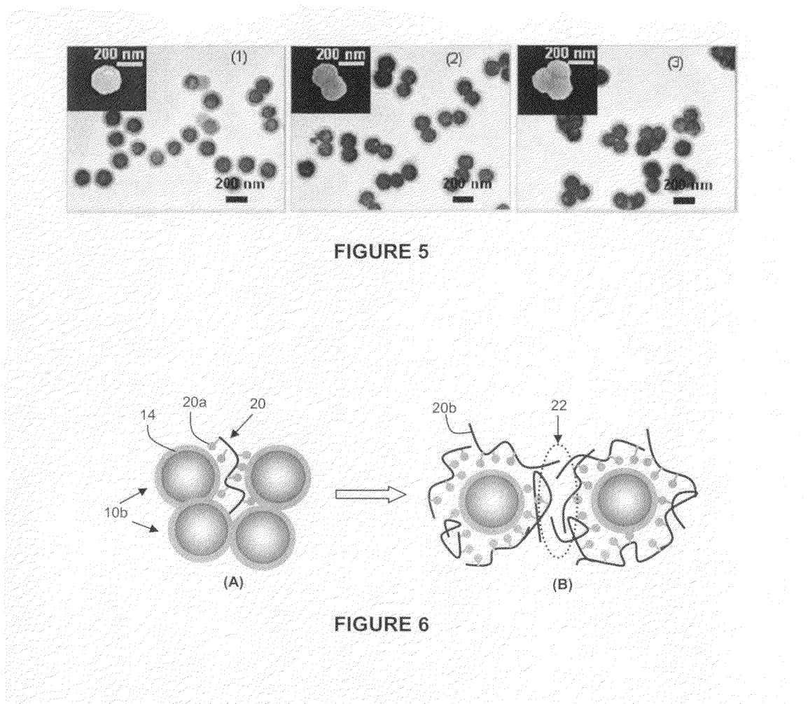

FIG. 5 shows TEM and scanning electron microscope (SEM) images of nanoaggregates 10d separated by centrifugation into single-core sandwich nanoparticles (1), double-core aggregates (2), and triple-core and poly-core aggregates (3). Although the product produced under the methods of the present disclosure was a mixture of nanoaggregates 10d, the simple compositions made the separation of each type of aggregate feasible. Each type of nanoaggregate 10d could be purified based on their distinct weights and sizes. Several separation methods were effective, such as size-exclusive chromatography, gravitational field-flow fractionation, and centrifugation, etc. Centrifugation was the most simple and economical way to separate the three types of nanoaggregates 10d. Using different centrifuge speeds, the single (1), double (2), and triple (3) building block aggregates were separated effectively after three cycles of centrifugation. The relationship of the centrifuge speed with the separation efficiency is shown in TABLE 1.

TABLE 1
Effect of Centrifuge Speed on Separation of Nanoaggregates.

| Centrifuge | Percentage | | |
|---|---|---|---|
| Speed (rpm) | Single-core (1) | Double-core (2) | Triple & Poly-core (3) |
| <500 | 8 | 15 | 77 |
| 500-800 | 32 | 53 | 15 |
| 1200-2000 | 91 | 7 | 2 |

FIG. 6 is a schematic diagram proposing a possible pathway on how the amount of PVP affected the extent of aggregation, including SiO₂—Au core-shell nanoparticle building blocks 10b having Au shell 14, PVP 20 having hydrophilic side group 20a and hydrophobic main chain 20b, and steric stabilization region 22. On the basis of the mechanism of steric protection of PVP-stabilized particles due to their amphiphilic and nonionic properties, PVP 20 hydrophilic side groups 20a adsorbed on the surfaces of building blocks 10b while the hydrophobic main chains 20b were kept away from the surfaces of the building blocks. FIG. 6(A) shows that as a small amount of PVP 20 molecules was used, there were not enough PVP molecules 20 on a building block 10b surface. The low stability of building block 10b would cause natural aggregation as described with reference to FIG. 2 above. Meanwhile, a few building blocks 10b might be linked to one PVP 20 molecule's hydrophilic groups 20a. In this condition, a high percentage of poly-core nanoaggregates was formed. FIG. 6(B) shows that as the PVP 20 concentration was increased, each building block 10b surface owned more PVP 20 molecules. Their hydrophobic main chains 20b executed the function of steric resistance, and stabilized the nanoparticles from aggregation by creating steric stabilization region 22 between the nanoparticles. When the number of PVP 20 molecules per surface area on the building block 10b surface reached its saturated value to form stabilized building blocks 10c, the percentages of each type of the nanoaggregates 10d nearly became constant.

The concentration of the PVP-stabilized building blocks 10c in the Stöber solution affected the formation of nanoaggregates as well. As the ratio of stabilized building blocks 10c to TEOS amount was changed, a high concentration of stabilized building blocks 10c led to more poly-core nanoaggregates 10d. Meanwhile, a small amount of pure silica nanoparticles was formed, resulting in impurity of the sandwich nanoaggregates 10d. Thus, the adjustment of stabilized building block 10c concentration was not preferred to regulate the aggregation of stabilized building blocks 10c.

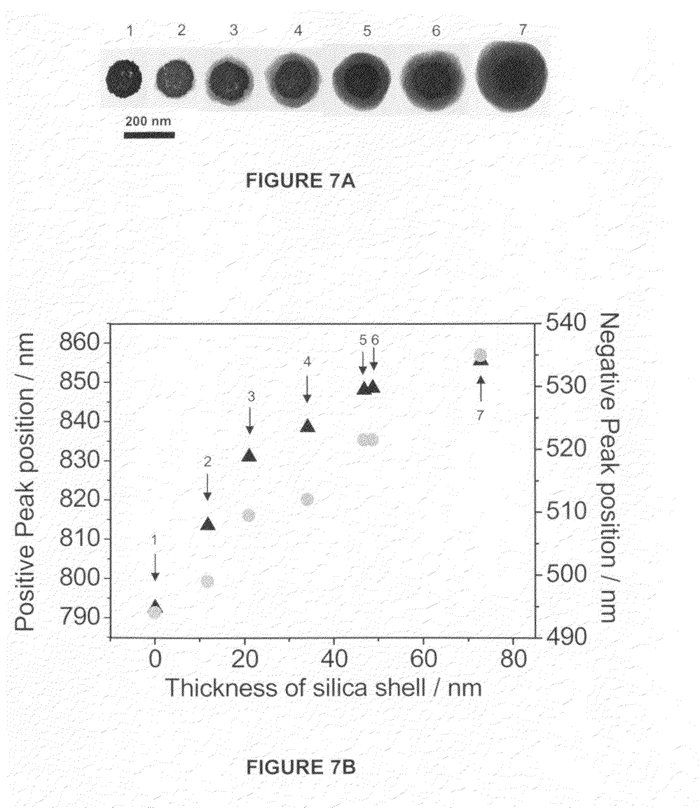

FIG. 7A shows TEM images of a series of seven single-core nanoaggregates 10d with increasing thicknesses of silica shell 18 from left to right (labeled 1 through 7). The amount of TEOS had less effect on the composition of nanoaggregates 10d, but played an important role on the thickness of silica shell 18. As the amount of TEOS was increased from 2 μL to 15 μL, the thickness silica shell 18 was increased from 12 nm to 73 nm. The thickness of silica shell 18 affected the plasmon band wavelengths slightly. As the silica shell 18 became thicker, red shifts were measurable.

FIG. 7B shows the relationship between the thickness of silica shell 18 and the plasmon band positions of the seven single-core nanoaggregates 10d (1-7) pictured in FIG. 7A, with triangles and circles indicating the maximum positive and negative absorption peak positions, respectively, of each nanoaggregate 1-7. Both the positive peak and the negative peak in the plasmon band were shifted to longer wavelengths as silica shell 18 thickened. Therefore, in an attempt to tune the plasmon band wavelength within a small range, the adjustment of thickness of silica shell 18 was preferable.

The following discussion in Examples 1-4 includes further experimental details regarding the methods and results described above for producing nanoaggregates 10d, and Example 5 includes methods of the present disclosure for enhancing NIR fluorescent signals using nanoaggregates 10d and the results of these methods.

### Example 1

### Synthesis of Pre-Building Blocks 10a of SiO₂—Au Nanoparticles

The synthesis of pre-building block 10a included three steps. First, the SiO₂ nanoparticle 10 cores were synthesized using a reverse microemulsion method. To adsorb Au-nanoparticles 12 on the SiO₂ nanoparticle 10 surface, 50.0 μL of 3-aminopropyltriethoxysilane (APTS) was added to the microemulsion to provide amino groups on SiO₂ nanoparticle 10 surfaces. The size of SiO₂ nanoparticle 10 cores was adjusted by using different amounts of water. After effective washing, SiO₂ nanoparticles 10 were resuspended into 40.0 mL of ethanol as a stock solution. The SiO₂ nanoparticle 10 concentration was 3.8×10¹¹ particles/mL.

Second, Au-nanoparticles 12 having a diameter of 4±1 nm were synthesized. 4 mL of 1.0% chloroauric acid (HAuCl₄) aqueous solution and 0.5 mL of 0.2 M K₂CO₃ were added into 100.0 mL of MilliQ water (18.6 Ω·cm⁻¹) in a ice bath. With vigorous stirring, the solution color turned from bright yellow to colorless. Then 1.0 mL of 0.5 mg/mL sodium borohydride solution was added to the above solution. The procedure was repeated for five times. The color of the solution changed from bluish-purple to reddish-orange. The solution was stirred for 5.0 min after the completion of sodium borohydride addition. The Au-nanoparticle 12 solutions were kept in the refrigerator at 4.0° C. before use.

Third, 1.0 mL of stock SiO₂ nanoparticle 10 solution was dropwise added into 40.0 mL of Au-nanoparticle 12 solution with vigorous stirring. The Au-nanoparticles 12 were adsorbed on the SiO₂ nanoparticle 10 cores through electrostatic force after a 6.0 min reaction. Surplus Au-nanoparticles 12 were separated by centrifuging at a speed of 6,500 rpm for 12.0 min. The supernatant was carefully removed. The purplish red precipitate was SiO₂—Au pre-building block nanoparticles 10a. Here, the particle suspended solution showed a dark red color. The pre-building blocks 10a were not stable. The precipitate was then resuspended into 10.0 mL of water in an ultrasonic bath for further growth of Au.

### Example 2

### Synthesis and Stabilizing of the SiO₂—Au Core-Shell Building Blocks 10b

The unstable Au-nanoparticles 12 on the pre-building block 10a nanoparticle surface were grown in a gold growth solution to form Au-shell 14. The gold growth solution consisted of 1.0 mL of 1.0×10⁻² g/mL chloroauric acid and 25.0 mg of K₂CO₃ in 90.0 mL water. Under vigorous stirring, the solution turned transparent and colorless. Then, 10.0 mL of SiO₂—Au nanoparticle 10a aqueous solution (containing about 3.8×10¹¹ particles/mL) was added into the gold growth solution. The reaction started when 0.5 M of hydroxylamine hydrochloride was slowly added. The color of mixture was first clear pink, then turned to purple and blue, and finally dark green, indicating an Au shell 14 was produced to form SiO₂—Au core-shell nanoparticle building blocks 10b. The total consumed hydroxylamine hydrochloride was 1.0 mL. To stabilize SiO₂—Au core-shell building blocks 10b, PVP (0.1 g/mL) was added to the above solution. After an overnight stirring, the surplus PVP was removed by centrifuging at a speed of 3,500 rpm for 15.0 min. Finally, the SiO₂—Au core-shell stabilized building block 10c nanoparticles with PVP coating 16 were resuspended into 10.0 mL of EtOH as the stock building block solution.

### Example 3

### Development of the Sandwich Nanoaggregates 10d

One, two, three and multiple SiO₂—Au stabilized building blocks 10c congregated during the formation of silica shell 18. A 2.5 mL portion of SiO₂—Au building blocks 10c was diluted to 10.0 mL using ethanol. 0.12 mL of water, 4.0 μL of TEOS and 1.0 mL of ammonia (29%) were added into the above solution. The SiO₂—Au stabilized building blocks 10c spontaneously aggregated during the process of formation of silica shell 18. After a one-hour reaction, the sample was centrifuged at a speed of 3,500 rpm for 15.0 min. Finally, the particles were washed by ethanol at least three times. The thickness of the silica shell 18 was dependent on the amount of TEOS.

The size and morphology of the particles were characterized using a Hitachi 7500 TEM, operating at 80 kV, and a Hitachi 4700 field SEM. The UV-visible spectra were obtained from the Shimadzu UV 2501 PC spectrophotometer. Jobin-Yvon-Horiba Fluorometer 3 Model FL 3-11 and the Olympus IX 71 fluorescence microscope were used to measure fluorescence signals.

### Example 4

### Purification of the Single, Double, and Triple Building Block Core Nanoaggregates 10d

The separation and purification of nanoaggregates 10d were conducted by adjusting the centrifuge speeds as described with reference to FIG. 5 and TABLE 1 above. The single, double, triple and poly core aggregates were obtained from the precipitants at the centrifuge speeds of 1,200-2,000 rpm, 500-800 rpm, and below 500 rpm. Three rounds of centrifugation were preferred to obtain purified products.

### Example 5

### Preparation of Dye-Doped Sandwich Nanoaggregates

NIR 797 isothiocyanate (1′-bis(4-sulfobutyl)-11-(4-isothiocyanatophenylthio)-3,3,3′,3′-tetramethyl-10,12-trimethyleneindotricarbocyanine monosodium salt, from Sigma-Aldrich Co.) was chosen as a fluorescent probe. To link the NIR dye molecules into the silica shell 18, we first linked the NIR 797 to an aminosilane precursor. The fluorescence spectra proved NIR 797 was doped into the silica matrix. The dye-doped sandwich particles were prepared similarly as the development of the sandwich nanoaggregates 10d, but the APTS-dye complex (40 μL, 0.9 mg/mL) was added at the last step.

### Example 6

### Testing Signal Enhancement of Dye-Doped Sandwich Nanoaggregates

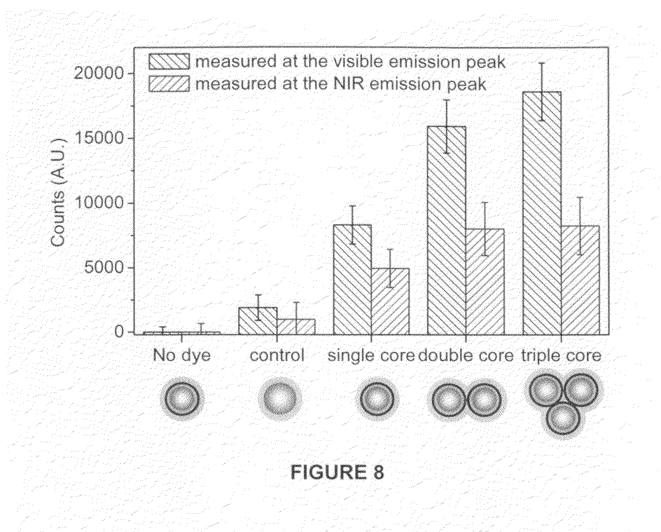

FIG. 8 is a graph showing the fluorescence enhancement of nanoaggregates for NIR 797 dye molecules. Single, double, and triple-core sandwich nanoaggregates demonstrated signal enhancement at different levels. A NIR fluorescent molecule, NIR 797 isothiocyanate, was doped into the silica outer shell 18 of these nanoaggregates as described above in Example 5. To verify the fluorescence enhancement, two control nanoparticles were used. The first control was a sandwich nanoparticle without dye. The second one was the sandwich nanoparticles doped with NIR 797 but without Au shell 14. The fluorescence intensities of each nanoaggregate were measured at two emission peaks (visible: 535 nm; NIR: 775 nm) as shown in FIG. 8. Compared to dye doped in nanoaggregates without Au shell 14, the fluorescence intensities of NIR 797 in the sandwich nanostructure were obviously amplified. The emission peak in the visible wavelength was enhanced slightly higher than that of the NIR one. The enhancement extents were 5.5 fold (single core), 8.4 fold (double core), and 9.9 fold (triple core). Meanwhile, the NIR peak was amplified by 4.4 times (single core), 8.2 times (double core), and 8.4 times (triple core).

Due to the low background signals in the NIR region, a few orders of signal enhancement will be significant for improving detection sensitivity of trace biological samples if these aggregates were applied as signaling reagents. Furthermore, unlike irregular poly aggregates which result in a large standard deviation of signal intensities, the uniformity of the aggregates produced by the methods of the present disclosure will provide consistent signal intensity for accurate measurements.

With regard to materials used for the examples above, tetraethylorthosilicate (TEOS), polyoxyethylene(10) isooctylphenylether [Triton X-100, 4-(C8H17)C6H4(OCH2CH3)10-OH], and methyl sulfoxide (DMSO) were purchased from Acros Organics. Sodium citrate, gold(III) chloride trihydrate (HAuC14.3H2O, 99.9+%), hydroxylamine hydrochloride (98%, A.C.S grade), 3-Aminopropyltriethoxysilane (APTS, 95%), sodium borohydride (>98%), polyvinylpyrrolidone molecule (PVP-10, average molecular weight of 10 kg/mol), and NIR 797 isothiocyanate (1′-bis(4-sulfobutyl)-11-(4-isothiocyanatophenylthio)-3,3,3′,3′-tetramethyl-10,12-trimethyleneindotricarbocyanine monosodium salt) were purchased from Sigma-Aldrich Inc. Ammonia (28-30%, GR) was purchased from EM Industries Inc. 1-Hexanol (99+%) was purchased from Alfa Aesar. Potassium carbonate (K2CO3.1.½H2O, A.C.S Grade), cyclohexane (HPLC grade) and ethanol (95%) were purchased from Fisher Scientific. MilliQ water (18.6 Ω·cm-1) was used to make aqueous solutions.

Although the present invention has been described with reference to preferred embodiments, workers skilled in the art will recognize that changes may be made in form and detail without departing from the spirit and scope of the invention. For example, it may be appreciated that metals such as silver (Ag) may also be used to give a strong SERS enhancement of dye-doped nanoaggregates, along with other metals having similar properties.

1. A method comprising:
forming nanoparticle cores;
forming a metal shell on a surface of the nanoparticle cores to produce nanoaggregate building blocks;
coating the nanoaggregate building blocks with a concentration of polyvinylpyrrolidone molecules; and
producing nanoaggregates from the building blocks comprising a mixture of single-core nanoaggregates, double-core nanoaggregates, and triple-core nanoaggregates as a function of the concentration of polyvinylpyrrolidone molecules coating the nanoaggregate building blocks.

2. The method of claim 1, further comprising controlling the concentration of polyvinylpyrrolidone molecules that will produce a desired percentage of the single-core, double-core, and triple-core nanoaggregates in the mixture.

3. The method of claim 1, further comprising forming a shell around the nanoaggregates.

4. The method of claim 3, wherein tetraethylorthosilicate is used to form the shell.

5. The method of claim 4, further comprising controlling the amount of tetraethylorthosilicate that will produce a desired percentage of the single-core, double-core, and triple-core nanoaggregates in the mixture, wherein producing nanoaggregates from the building blocks comprising the mixture of single-core nanoaggregates, double-core nanoaggregates, and triple-core nanoaggregates is further as a function of an amount of tetraethylorthosilicate used.

6. The method of claim 1, further comprising controlling the concentration of the building blocks that will produce a desired percentage of the single-core, double-core, and triple-core nanoaggregates in the mixture, wherein producing nanoaggregates from the building blocks comprising the mixture of single-core nanoaggregates, double-core nanoaggregates, and triple-core nanoaggregates is further as a function of a concentration of the building blocks used to produce the nanoaggregates.

7. The method of claim 1, wherein the nanoparticle cores comprise SiO₂.

8. The method of claim 1, wherein the SiO₂ nanoparticle cores are formed using a reverse microemulsion method.

9. The method of claim 1, wherein the metal shell comprises gold.

10. The method of claim 10, wherein forming the metal shell on the surface of the nanoparticle cores to produce the nanoaggregate building blocks comprises adsorbing gold nanoparticles onto the surface of the nanoparticle cores and growing the gold nanoparticles in a growth solution to form the metal shell.

11. The method of claim 1, wherein the metal shell comprises silver.

12. The method of claim 1, further comprising separating the single-core, double-core, and triple-core nanoaggregates from the mixture by centrifuging the mixture at different centrifugation speeds.

13. A method comprising:
forming nanoparticle cores;
forming a metal shell on a surface of the nanoparticle cores to produce nanoaggregate building blocks;
controlling a concentration of polyvinylpyrrolidone molecules to coat the nanoaggregate building blocks based on a known relationship between the concentration and an extent of aggregation of the building blocks; and
producing nanoaggregates from the building blocks comprising a mixture of single-core nanoaggregates, double-core nanoaggregates, and triple-core nanoaggregates as a function of the extent of aggregation.

14. The method of claim 3, wherein controlling the concentration of polyvinylpyrrolidone molecules includes selecting a concentration that will produce a desired percentage of the single-core, double-core, and triple-core nanoaggregates in the mixture.

15. The method of claim 13, further comprising forming a shell around the nanoaggregates.

16. The method of claim 15, wherein tetraethylorthosilicate is used to form the shell.

17. The method of claim 16, further comprising controlling the amount of tetraethylorthosilicate that will produce a desired percentage of the single-core, double-core, and triple-core nanoaggregates in the mixture, wherein producing nanoaggregates from the building blocks comprising the mixture of single-core nanoaggregates, double-core nanoaggregates, and triple-core nanoaggregates is further as a function of an amount of tetraethylorthosilicate used.

18. The method of claim 13, further comprising controlling the concentration of the building blocks that will produce a desired percentage of the single-core, double-core, and triple-core nanoaggregates in the mixture, wherein producing nanoaggregates from the building blocks comprising the mixture of single-core nanoaggregates, double-core nanoaggregates, and triple-core nanoaggregates is further as a function of a concentration of the building blocks used to produce the nanoaggregates.

19. A composition comprising:
a nanoaggregate mixture comprising a percentage of single-core, double-core, and triple-core nanoaggregates, each nanoaggregate comprising nanoparticle cores, with each nanoparticle core having a metal shell; and
a concentration of polyvinylpyrrolidone molecules adsorbed to each nanoaggregate to produce the percentage of single-core, double-core, and triple-core nanoaggregates in the mixture.

20. The composition of claim 19, further comprising a silica shell surrounding each nanoaggregate.
